(19) United States
(12) Patent Application Publication
(10) Pub. No.: US 2022/0103385 A1
(43) Pub. Date: Mar. 31, 2022

(54) POE SWITCH

(71) Applicant: GUANGDONG UNIPOE IOT TECHNOLOGY CO., LTD., Dongguan (CN)

(72) Inventors: Jiang Liu, Dongguan (CN); Xiaoyong Lu, Dongguan (CN); Yu Jiang, Dongguan (CN)

(21) Appl. No.: 17/643,062

(22) Filed: Dec. 7, 2021

Related U.S. Application Data
(63) Continuation-in-part of application No. PCT/CN2020/071639, filed on Jan. 13, 2020.

(51) Int. Cl. H04L 12/10; G09G 3/36; G06F 3/02

(52) U.S. Cl. CPC H04L 12/10; G09G 2354/00; G06F 3/0227; G09G 3/36

(57) ABSTRACT

A POE switch includes a switch module, a POE power supply module and a standard selection module. The microcontroller is communicatively connected with the POE power supply module, the selection unit is connected with the microcontroller and configured to receive an external operation and output an operation signal to the microcontroller, and the microcontroller is configured to control the POE power supply module to supply power to the PD with a corresponding power supply standard according to the operation signal. By operating the selection unit, the microcontroller can control the POE power supply module to supply power to the PD with a corresponding power supply standard. One PSE can supply power to all types of PDs, therefore the compatibility of the POE switch is improved, and the flexibility of building a POE system is improved accordingly.

### CROSS-REFERENCE TO RELATED APPLICATION

This application is a continuation-in-part application of International (PCT) Patent Application No. PCT/CN2020/071639, filed on Jan. 13, 2020. The contents of the above-identified application are incorporated herein by reference.

### FIELD OF THE INVENTION

The present invention relates to the technical field of switches, and more particularly to a POE (Power Over Ethernet) switch supporting multiple power supply standards.

### BACKGROUND OF THE INVENTION

With the increasing popularity of the Internet, POE switches have been used more and more widely, which have the advantages of simple wiring, low cost, and high security. A complete POE (Power Over Ethernet, Active Ethernet) system includes power sourcing equipment (PSE) that supplies power to the Ethernet client device and power devices (PDs) that are PSE loads (client devices, such as IP phones, network security cameras, wireless APs, and handheld computers) accepting the power.

The traditional POE switch can only support a single power supply standard such as IEEE802.3Bt, POH or UPOE standard. Specifically, the IEEE802.3Bt standard may output a respective power supply according to eight classification levels of PDs; while the POH and UPOE standards supply power according to four-pair technique (That is, all eight wires are powered), which provide a power supply of 90 W regardless of the classification level of the PDs. However, multiple PSEs and PDs are often used in the construction of existing POE systems. If multiple types of PDs are included in the POE system, the existing PSE cannot adaptively supply power for various types of PDs, leading to a poor compatibility.

### SUMMARY OF THE INVENTION

The purpose of the present invention is to provide a POE switch that can support multiple power supply standards, so that one PSE can supply power to various types of PDs and improve the compatibility of the POE switch.

To achieve the mentioned above purpose, the present invention provides a POE switch which includes a switch module, configured for data interaction with external communication equipment; a POE power supply module, configured for electrical connection with a power device (PD) to output power supply to the PD; and a standard selection module including a selection unit and a microcontroller. The microcontroller is communicatively connected with the POE power supply module, the selection unit is connected with the microcontroller and configured to receive an external operation and output an operation signal to the microcontroller, and the microcontroller is configured to control the POE power supply module to supply power to the PD with a corresponding power supply standard according to the operation signal.

In comparison with the prior art, The POE switch of this application is equipped with a standard selection module including a selection unit and a microcontroller. The microcontroller is connected to the POE power supply module for communication, and the selection unit is connected to the microcontroller. When there is a need to use the POE switch to supply power to the PDs, by operating the selection unit, the microcontroller can control the POE power supply module to supply power to the PD with a corresponding power supply standard, thereby supplying the PD with a compatible power supply. That is to say, one PSE can supply power to all types of PDs, therefore the compatibility of the POE switch is improved, the flexibility of building a POE system is improved accordingly, and thus a backup solution for PD switching is provided.

Preferably, the selection unit is a keying circuit unit comprising a plurality of keys respectively connected to the microcontroller, and the microcontroller is configured to monitor a respective operation signal for each key.

Preferably, the keys are physical keys.

Preferably, the selection unit includes a menu key, an up key, a down key, a confirm key, and a return key.

Preferably, the POE switch further includes a display module, wherein the display module is electrically connected to the microcontroller and configured to display a respective power supply standard based on the respective operation signal for each key.

Preferably, the display module is an LCD display screen.

Preferably, the power supply standard includes at least one of IEEE802.3Bt, POH, and UPOE standards.

Preferably, a model of the microcontroller includes STC15L2K60 or SH79F7416.

### BRIEF DESCRIPTION OF THE DRAWINGS

The accompanying drawings facilitate an understanding of the various embodiments of this invention. In such drawings:

FIG. 1 is a structural block diagram of a POE switch according to an embodiment of the present invention;

FIG. 2a is a circuit diagram of a microcontroller of a POE switch according to an embodiment of the present invention;

FIG. 2b is a circuit diagram of a microcontroller of a POE switch according to another embodiment of the present invention; and

FIG. 3 is a schematic circuit diagram of a selection unit of a POE switch according to an embodiment of the present invention.

### DETAILED DESCRIPTION OF ILLUSTRATED EMBODIMENTS

The present invention will be described in detail below with reference to the accompanying drawings and preferred embodiments.

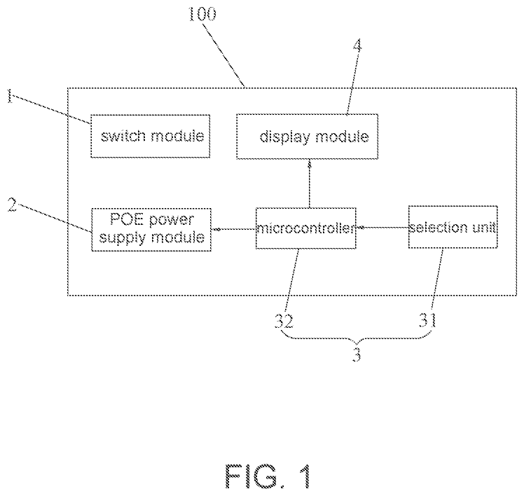

As illustrated in FIGS. 1-3, a POE switch 100 provided in the present invention can switch to a corresponding power supply standard (including but not limited to IEEE802.3Bt standard, POH standard, UPOE standard, etc.) responding to an external operation, so as to provide a suitable power supply to different PDs. Specifically, the POE switch 100 of the present invention includes a switch module 1, a POE power supply module 2, and a standard selection module 3. The switch module 1 is configured for data interaction with external communication equipment, which performs data forwarding and data storage by matching its main chip with various chips and peripheral circuits, and finally proceeds with data interaction with the external communication device through a network port (such as RJ45). The specific implementation process for the data interaction between the switch module 1 and the external communication device is an existing technology, which will not be repeated here therefore. The POE power supply module 2 is configured to electrically connect the PD to output power supply to the PD. The standard selection module 3 includes a selection unit 31 and a microcontroller 32. The microcontroller 32 is communicatively connected with the POE power supply module 2 through a flexible flat cable, the selection unit 31 is connected with the microcontroller 32 and configured to receive an external operation and output an operation signal to the microcontroller 32, and the microcontroller 32 is configured to then control the POE power supply module to supply power to the PD with a corresponding power supply standard according to the operation signal, thereby supplying a suitable power to the PD.

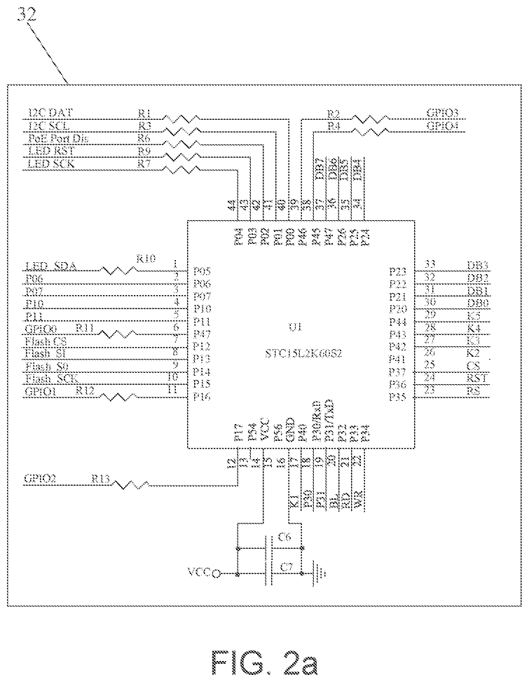

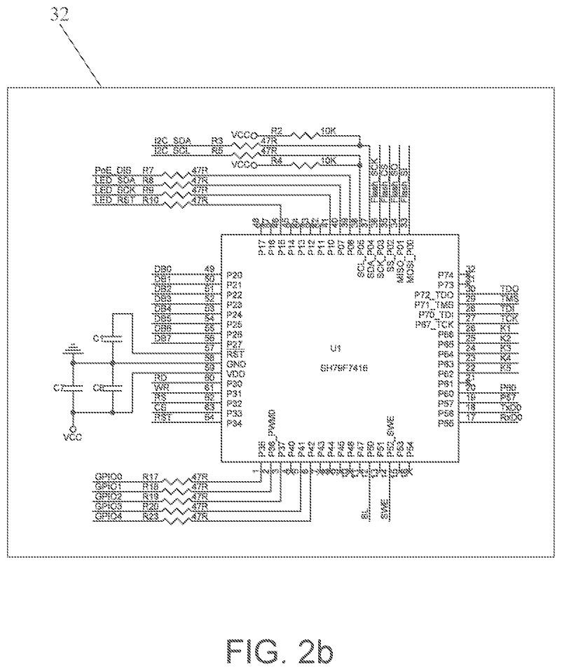

As optional embodiments, a model of the microcontroller 32 may be STC15L2K60, SH79F7416, or other compatible microcontrollers. In this embodiment, the microcontroller 32 with a model of STC15L2K60S2 is used, as illustrated in FIG. 2a, which is not limited here. A model of STC15L2K60S4 also may be used, for example. Specifically, the POE power supply module 2 includes a switch chip (not shown) and a power supply circuit (not shown) connected to the switch chip. The power supply circuit may provide twenty-four power supply ports. Of course, in some embodiments, the POE switch 100 may only provide eight ports, sixteen ports, etc., which is not limited here.

As another embodiment, the microcontroller 32 with a model of SH79F7416 is used, as illustrated in FIG. 2b.

Specifically, when the PD is applied with a power supply standard of IEEE802.3Bt, the POE switch 100 will classify the PD according to the feedback of the characteristic resistance of the PD, and output the corresponding power supply according to the classification level to supply power to the PD. When the PD is applied with a POH or UPOE power supply standard, the POE switch 100 will detect the PD and control the POE power supply module 2 to supply a power of 90 W to the PD, regardless of the classification level of the PD.

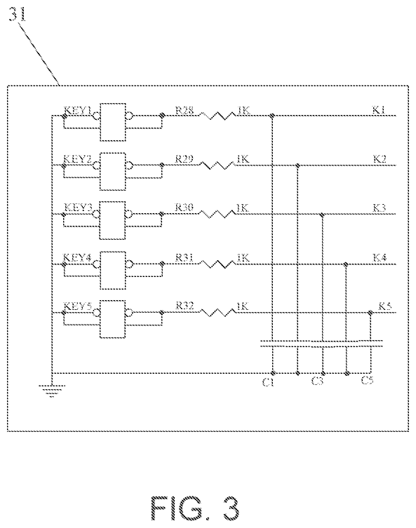

Referring to FIG. 3, specifically, the selection unit 31 is a keying circuit unit configured on the POE switch 100, which includes a plurality of keys electrically connected to the microcontroller 32. By monitoring operation signals of the keys, the microcontroller 32 may control the POE power supply module 2 to supply power to the PD with a corresponding power supply standard, which has a simple structure, convenient operation and low cost. Of course, in some embodiments, the selection unit 31 may be other components, such as a terminal device, which sends an operation signal to the microcontroller 32, so that the microcontroller 32 controls the POE power supply module 2 to switch the power supply standard according to the operation signal. In some embodiments, the selection unit 31 may be a remote controller wirelessly connected to the microcontroller 32, which sends an operation signal to the microcontroller 32 by operating the keys of the remote control. It should be noted that the specific implementation ways of the selection unit 31 is not limited.

More specifically, the keys are physical keys, which are not limited. In some embodiments, the keys may be touch keys or the like. Preferably, the selection unit 31 includes a menu key KEY1, an up key KEY2, a down key KEY3, a confirm key KEY4, and a return key KEY5, which are respectively connected to the ports K1, K2, K3, K4, K5 of the microcontroller 32. A menu of power supply mode is entered by operating the menu key KEY1, and the power supply standard can be selected by operating the up key KEY2 and the down key KEY3 and then confirmed by operating the confirm key KEY4. When there is a need to review the power supply mode menu, a menu page may be returned by operating the return key KEY5. For example, in one embodiment, there are three power supply standards includes IEEE802.3Bt, POH and UPOE standards. If the current power supply standard is POH standard, and the up key KEY2 is pressed and then the confirm key KEY4 is pressed, the microcontroller 32 will control the POE power supply module 2 to supply power in the IEEE802.3Bt power supply standard; if the down key KEY3 is pressed and then the confirm key KEY4 is pressed, the microcontroller 32 will control the POE power supply module 2 to supply power in the UPOE power supply standard. For another example, in one embodiment, if the current power supply standard is IEEE802.3Bt standard, when the up key KEY2 is pressed and then the confirm key KEY4 is pressed, the microcontroller 32 will control the POE power supply module 2 to supply power in the UPOE power supply standard; when the down key KEY3 down is pressed and then the confirm key KEY4 is pressed, the microcontroller 32 will control the POE power supply module 2 to supply power in the POH power supply standard.

Specifically, the POE switch 100 of the present application further includes a display module 4, which is electrically connected to the microcontroller 32 for displaying various power supply standards according to the respective operation signal of each key, so that the operator can intuitively view the current power supply mode of the POE switch 100. For example, when IEEE802.3Bt standard is selected, only the selected standard will be displayed on the display module 4. When UPOE standard is selected, only the selected standard will be displayed on the display module 4. In some embodiments, the display module 4 may display various power supply standards (including but not limited to IEEE802.3Bt, POH, UPOE, etc.). For example, if IEEE802.3Bt standard is selected, font color of the IEEE802.3Bt column will change to other colors (such as from white to green, etc.). Preferably, the display module 4 is an LCD display screen, which is not limited however.

Compared with the prior art, the POE switch 100 of the present invention is provided with a standard selection module 3 including a selection unit 31 and a microcontroller 32. The microcontroller 32 is in communication connection with the POE power supply module 2, and the selection unit 31 is connected with the microcontroller 32. When there is a need to use the POE switch to supply power to the PDs, by operating the selection unit, the microcontroller can control the POE power supply module to supply power to the PD with a corresponding power supply standard, thereby supplying the PD with a compatible power supply. That is to say, one PSE can supply power to all types of PDs, therefore the compatibility of the POE switch 100 is improved, the flexibility of building a POE system is improved accordingly, and thus a backup solution for PD switching is provided.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A POE (Power Over Ethernet) switch, comprising:
a switch module, configured for data interaction with external communication equipment;
a POE power supply module, configured for electrical connection with a power device (PD) to output power supply to the PD; and
a standard selection module, comprising a selection unit and a microcontroller, wherein the microcontroller is communicatively connected with the POE power supply module, the selection unit is connected with the microcontroller and configured to receive an external operation and output an operation signal to the microcontroller, and the microcontroller is configured to control the POE power supply module to supply power to the PD with a corresponding power supply standard according to the operation signal.

2. The POE switch of claim 1, wherein the selection unit is a keying circuit unit comprising a plurality of keys respectively connected to the microcontroller, and the microcontroller is configured to monitor a respective operation signal for each key.

3. The POE switch of claim 2, wherein the keys are physical keys.

4. The POE switch of claim 2, wherein the selection unit includes a menu key, an up key, a down key, a confirm key, and a return key.

5. The POE switch of claim 4, further comprising a display module, wherein the display module is electrically connected to the microcontroller and configured to display a respective power supply standard based on the respective operation signal for each key.

6. The POE switch of claim 5, wherein the display module is an LCD display screen.

7. The POE switch of claim 1, wherein the power supply standard includes at least one of IEEE802.3Bt, POH, and UPOE standards.

8. The POE switch of claim 1, wherein a model of the microcontroller includes STC15L2K60 or SH79F7416.
